(19) United States
(12) Patent Application Publication
(10) Pub. No.: US 2009/0138243 A1
(43) Pub. Date: May 28, 2009

(54) INTERFERENCE CHECKING METHOD, COMPUTER-AIDED DESIGN DEVICE, AND INTERFERENCE CHECKING PROGRAM

(75) Inventors: Takayuki TOKUMARU, Fukuoka (JP); Hiroko Shimahara, Fukuoka (JP); Atsuo Tanaka, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/277,964

(22) Filed: Nov. 25, 2008

(30) Foreign Application Priority Data
Nov. 27, 2007 (JP) 2007-306426

(51) Int. Cl. G06F 17/50

(52) U.S. Cl. 703/1

(57) ABSTRACT

An interference checking method, a computer-aided design device, and an interference checking program determining whether an interference has occurred between components of a product. The interference checking method includes loading geometric form data of components acquired from a second storage section and checking whether an interference has occurred and evaluating a position design of the product in accordance with the geometric form data of the components that have been loaded in the second storage section.

### BACKGROUND

1. Field

The embodiments discussed herein are directed to an interference checking method of checking whether an interference has occurred between components constituting a product, a computer-aided design device performing an interference checking method, and an interference checking program causing a computer to perform an interference checking method, and more particularly to an interference checking method, a computer-aided design device, and an interference checking program suitable for a case where a product is a large-scale assembly constituted by a large number of components.

2. Description of the Related Art

In the case of product design using a computer-aided design (CAD) device, designing is performed by defining, as graphic data in three-dimensional coordinates, the form and layout of a product and the forms and installation positions of components constituting the product.

In such product designing, by performing arithmetic operations such as addition, subtraction, multiplication, and division on components by using three-dimensional coordinates and graphic data defined using CAD, a problem caused by interference occurring between the components can be found in advance.

Thus, in general, in the case of product design using CAD, a process to analyze and verify, via a computer employing CAD, three-dimensional form data generated using CAD is performed before a process to manufacture a trial product or a final product in accordance with a design drawing made using CAD is performed.

When a large-scale assembly constituted by a large number of components is designed, the components constituting the assembly are grouped into units according to functions or the like and the units are designed in parallel. Thus, when such an assembly constituted by a plurality of units is designed, a feature of detecting, based on three-dimensional graphic data defined using CAD, interference occurring between units that have been designed individually is effective for checking for design errors and input errors.

In order to reduce the processing time required for interference checking, various suggestions for reducing the number of components to be subjected to interference checking have been made.

A technology is proposed in Japanese Patent Application Laid-Open No. 2003-271687 in which the entire processing speed of interference checking for an assembly constituted by a plurality of units can be increased by obtaining a rectangular parallelepiped region representing the minimum outermost contour in a three-dimensional space including the units and performing simple checking by using the obtained rectangular parallelepiped region before performing strict interference checking in a memory section of a computer employing CAD, thus excluding, at an early stage, non-interference regions from targets of strict checking.

In addition, a technology is proposed in Japanese Patent Application Laid-Open No. 2006-285922 in which the entire processing speed of interference checking can be increased by performing interference checking only for particular components.

In addition, a technology is proposed in Japanese Patent Application Laid-Open No. 2006-48221 in which the entire processing speed of interference checking can be increased by setting an interference prohibition region in which components are prohibited from interfering with each other and performing interference checking only for the interference prohibition region.

However, in the above-described technologies of the related art, in a case where a unit includes a large number of components, a number of combinations of components to be subjected to interference checking increases. Thus, since interference checking must be performed in a round-robin fashion, an excellent processing response cannot be achieved.

In the case of a large-scale assembly such as a car or a train, a large number of components are to be subjected to interference checking. Thus, a large amount of time is necessary for the interference checking. Moreover, in some cases, interference checking cannot be successfully performed due to a failure in loading targets of interference checking into a memory section of a computer employing CAD.

In addition, in the above-described and similar technologies of the related art, it is necessary to take specific measures as preprocessing, such as setting of a certain region. Thus, a complicated operation must be performed in order to achieve processing.

### SUMMARY

The disclosed information processing apparatus includes a first storage section configured to store information of forms and positions of a plurality of components constituting a product, a second storage section configured to, in a case where position design of the product is performed by grouping the plurality of components into a plurality of units, cause geometric form data of components acquired from the information on forms and positions of the components stored in the first storage section to be loaded thereinto.

The information processing apparatus may include a first form calculation section configured to calculate a cubic form of each of the units, in accordance with information on forms and positions of components belonging to the unit read from the first storage section, a first simple checking section configured to check whether a collision (conflict) has occurred between cubic forms of two units calculated by the first form calculation section and, when a collision is detected, to output information on the two units for which a collision has been detected. A second form calculation section that is configured to calculate, in accordance with the information on the two units for which a collision has been detected received from the first simple checking section, a cubic form of a collision region of the two units for which a collision has been detected is provided.

The information processing apparatus may include a second simple checking section configured to check whether a collision has occurred between the cubic form of the collision region calculated by the second form calculation section and a cubic form of any one of components belonging to the two units for which a collision has been detected by the first simple checking section and, when a collision is detected between the cubic form of the collision region calculated by the second form calculation section and cubic forms of components belonging to the two units for which a collision has been detected by the first simple checking section, to output information on the components for which a collision has been detected; a loading execution section configured to load, into the second storage section, geometric form data of the components acquired in accordance with the information on the components received from the second simple checking section, and an interference checking section configured to check, in accordance with the geometric form data of the components that have been loaded in the second storage section, whether interference has occurred between the components and to evaluate the position design of the product.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating a functional configuration of a computer-aided design device;

FIG. 2 is a block diagram illustrating a hardware configuration of the computer-aided design device shown in FIG. 1;

FIG. 3 is a flowchart illustrating an interference checking process performed by the computer-aided design device shown in FIG. 1; and

FIG. 4 illustrates a specific example of the process shown in FIG. 3.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

An interference checking method, a computer-aided design device, and an interference checking program according to an embodiment of the present invention will be described with reference to the drawings.

According to the disclosed interference checking to be performed before components constituting a product are loaded into a memory section of a computer is performed only for units, which are grouped in terms of design. Thus, even in a case where a large number of components constitute each unit and a large number of combinations of components to be subjected to interference checking exist, interference checking can be performed independent of the influence of a large number of components constituting each unit, that is, interference checking for components in a round-robin fashion can be avoided.

In addition, interference checking to be performed before components constituting a product are loaded into a memory section of a computer is performed in a simple manner in which it is checked whether a collision has occurred between the forms of units. Thus, with the implementation of the above-described measures, an excellent processing response can be achieved.

Moreover, the number of components loaded into a memory section of a computer and subjected to strict interference checking can be significantly reduced. Thus, even for a large-scale assembly such as a car or a train, all the components necessary for interference checking can be loaded into the memory section of the computer so that interference checking can be performed.

According to the disclosed system and method, even in a case where a large number of components constitute each unit and a large number of combinations of components to be subjected to interference checking exist, an excellent processing response can be achieved in interference checking performed before components constituting a product are loaded into a memory section of a computer.

Furthermore, since the number of components loaded into a memory section of a computer and subjected to strict interference checking can be significantly reduced, even for a large-scale assembly such as a car or a train, strict interference checking can be performed in the memory section of the computer.

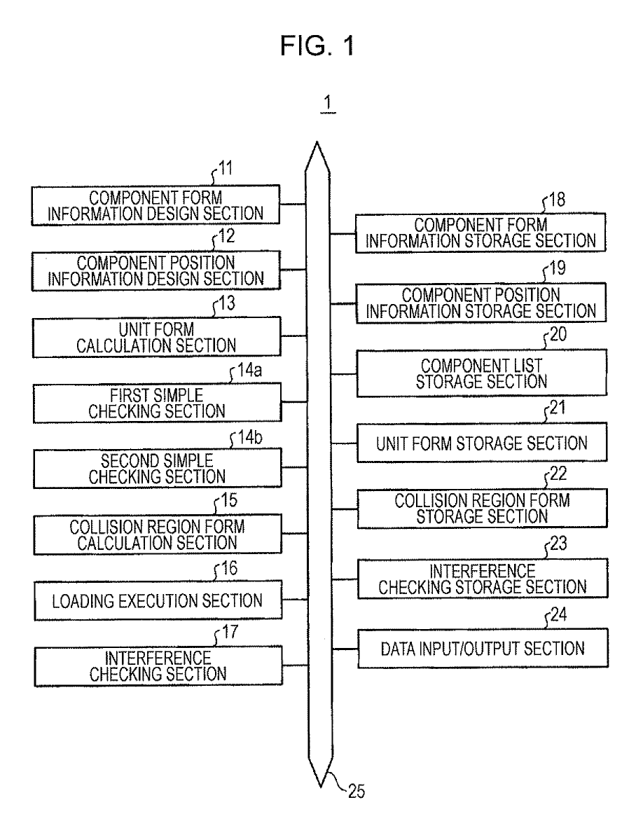

FIG. 1 is a block diagram showing an example of a functional configuration of a computer-aided design device according to an embodiment of the present invention.

A computer-aided design device 1 according to an embodiment shown in FIG. 1 includes a component form information design section 11, a component position information design section 12, a unit form calculation section 13, a first simple checking section 14a, a second simple checking section 14b, a collision region form calculation section 15, a loading execution section 16, an interference checking section 17, a component form information storage section 18, a component position information storage section 19, a component list storage section 20 for storing a list of components constituting each unit. The design device 1 of FIG. 1 may also include a unit form storage section 21, a collision region form storage section 22, an interference checking storage section 23, a data input/output section 24, and an information transfer path 25 to be used for transferring information among the above-mentioned sections. The above-mentioned sections relate to interference checking for a large-scale assembly, such as a car or a train, including a large number of components that are grouped into units according to function(s) such as an engine, the units being designed in parallel.

The component form information design section 11 generates, in accordance with data that relates to the form of a component and that is input from the data input/output section 24, component form information based on three-dimensional coordinates, and stores the generated component form information, in association with a name or symbol of the component, in the component form information storage section 18.

The component form information includes data of vertex coordinates, plane information, and the like for representing the form of the component.

The component position information design section 12 generates, in accordance with data that relates to a position of a component and that is input from the data input/output section 24, component position information based on three-dimensional coordinates, and stores the generated component position information, in association with the name or symbol of the component, in the component position information storage section 19.

The component position information includes position information representing an installation position of the component, direction information representing a direction of installation of the component, and the like.

A list (correspondence table) indicating one of a plurality of units, which have been individually designed, each component (information on a component represented by a name or a symbol) stored in the component form information storage section 18 and the component position information storage section 19 belongs is stored in the component list storage section 20.

The unit form calculation section 13 acquires, for each unit, all the components belonging to the unit from the component list storage section 20 in accordance with a key indicating an identification code of the unit, reads information on the form and position of each of the components from the component form information storage section 18 and the component position information storage section 19 in accordance with a key indicating the name or symbol of the component, calculates the external form (cube) of the unit in accordance with the read information of the forms and positions of the components, and stores the read external form (cube) of the unit in the unit form storage section 21.

The unit form calculation section 13 may perform the above-described form calculation processing at any time before interference checking is performed. However, for the sake of convenience of explanation, in an embodiment, the unit form calculation section 13 performs the form calculation processing when an instruction to start interference checking is input from the data input/output section 24.

The first simple checking section 14a checks whether a collision (conflict) has occurred between external forms of two units acquired from the unit form storage section 21.

The checking for collision performed here is referred to as “simple checking”.

If a collision has been detected, the first simple checking section 14a notifies the collision region form calculation section 15 of the two units colliding with each other. Then, the first simple checking section 14a waits, without entering a subsequent simple checking, until a resumption notice is received from the second simple checking section 14b.

If no collision has been detected, the first simple checking section 14a acquires the external form of the next unit from the unit form storage section 21 and performs similar checking.

In order to manage the above-described processing operations, the first simple checking section 14a includes a first counter configured to count a number of times simple checking has been performed.

Although the number of times simple checking has been performed is managed in a count-down mode in an embodiment, the number of times simple checking has been performed may be managed in a count-up mode.

The collision region form calculation section 15 calculates the form (cube) of a collision region of the two units notified from the first simple checking section 14a, and stores the obtained form of the collision region, in association with the two units (identification codes), in the collision region form storage section 22.

The second simple checking section 14b checks whether a collision has occurred between the form of the collision region read from the collision region form storage section 22 and any one of the external forms (cubes) of the components belonging to the units colliding with each other, where the external forms (cubes) of the components are acquired in accordance with information on the forms and positions of the components read from the component form information storage section 18 and the component position information storage section 19. If a collision has been detected, components corresponding to the collision region are transmitted to the loading execution section 16.

If no collision has been detected, the second simple checking section 14b instructs the first simple checking section 14a to start simple checking for the next unit.

In order to manage the above-described processing operations, the second simple checking section 14b includes a second counter configured to count a number of times simple checking has been performed.

Although the number of times simple checking has been performed is managed in a count-down mode in an embodiment, the number of times simple checking has been performed may be managed in a count-up mode.

The loading execution section 16 reads, in accordance with keys indicating the components received from the second simple checking section 14b, information on the forms and positions of the components from the component form information storage section 18 and the component position information storage section 19, and loads, into the interference checking storage section 23, three-dimensional geometric form data based on the information on the forms and positions of the components.

The interference checking section 17 checks, in accordance with the three-dimensional geometric form data of the components that have been loaded into the interference checking storage section 23, whether interference has occurred between the components, and transmits, from the data input/output section 24 to an output section such as a display or a printer, a result of the interference checking.

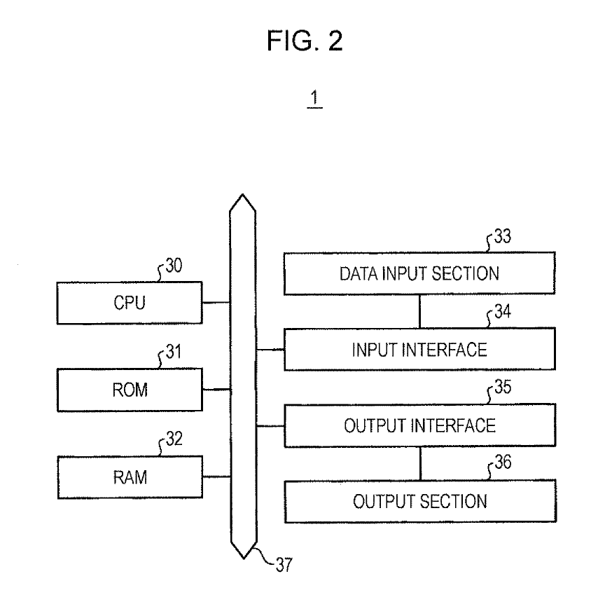

FIG. 2 is a block diagram showing an example of a hardware configuration of the computer-aided design device 1 shown in FIG. 1.

Referring to FIG. 2, the computer-aided design device 1 has a configuration of a so-called information processing device. That is, the computer-aided design device 1 includes a central processing unit (CPU) 30, a read-only memory (ROM) 31, a random-access memory (RAM) 32, a data input section 33, an input interface 34, an output interface 35, an output section 36, and a data bus 37 corresponding to the information transfer path 25 shown in FIG. 1.

The data input section 33 includes, for example, a keyboard, a pointing device, a mouse, and a touch panel. The output section 36 includes, for example, a display and a printer.

The data input section 33 is connected to the data bus 37 with the input interface 34, which is a connecting section, therebetween. The output section 36 is connected to the data bus 37 with the output interface 35, which is a connecting section, therebetween.

These sections correspond to the data input/output section 24 shown in FIG. 1.

Program(s) to be executed by the CPU 30, data to be used when the CPU 30 executes the program, and the like are stored in the ROM 31.

The various programs may include program(s) for attaining functions of the unit form calculation section 13, the first simple checking section 14a, the second simple checking section 14b, and the collision region form calculation section 15 shown in FIG. 1, as well as a program for performing integrated control of the entire device, a program for controlling data transfer between the data input section 33 and the output section 36 via the input interface 34 and the output interface 35 shown in FIG. 2, a program for attaining function(s) of the component form information design section 11 and the component position information design section 12, a program for attaining a function of the loading execution section 16, and a program for attaining a function of the interference checking section 17.

The RAM 32 includes at least one storage area. The RAM 32 includes storage areas to be used as the unit form storage section 21 and the collision region form storage section 22 shown in FIG. 1, as well as a storage area to be used for temporarily storing data when the CPU 30 executes a program and storage areas to be used as the component form information storage section 18, the component position information storage section 19, and the interference checking storage section 23 shown in FIG. 1.

The CPU 30 accesses, for example, the ROM 31 via the data bus 37 to read and execute the above-mentioned various programs. The CPU 30 attains function(s) of the component form information design section 11, the component position information design section 12, the unit form calculation section 13, the first simple checking section 14a, the second simple checking section 14b, the collision region form calculation section 15, the loading execution section 16, and the interference checking section 17 shown in FIG. 1.

In the process of attaining the function(s), the CPU 30 performs processing of accessing the input interface 34 via the data bus 37 to acquire data and instructions entered via the data input section 33 by a user, accessing the RAM 32 via the data bus 37 to store data into the above-mentioned storage areas, and accessing the output interface 35 via the data bus 37 to output a result of interference checking to the output section 36.

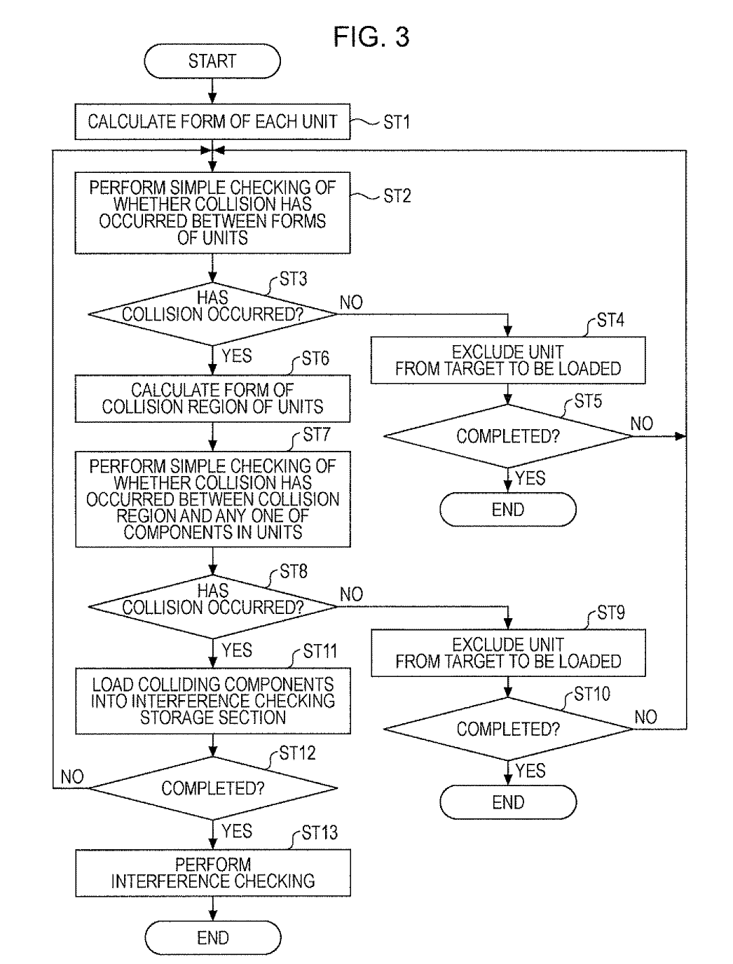

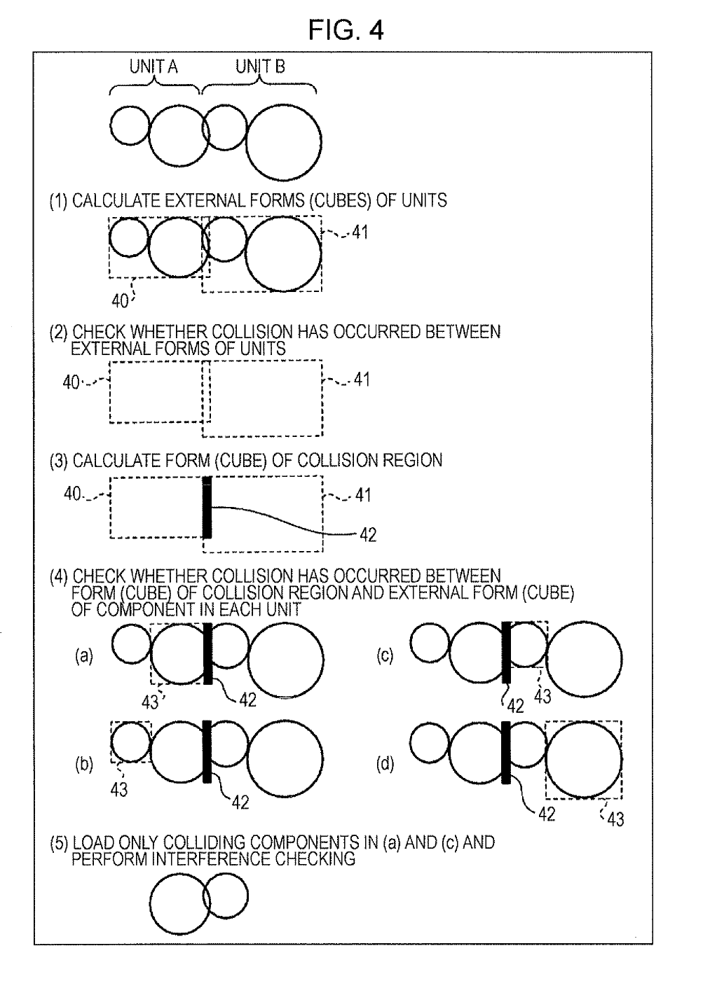

An interference checking process performed by the computer-aided design device 1 having the above-described configuration shown in FIG. 1 will now be described with reference to FIGS. 3 and 4.

FIG. 3 is a flowchart showing an interference checking process performed by the computer-aided design device 1 shown in FIG. 1.

FIG. 4 illustrates a specific example of the process shown in FIG. 3.

Referring to FIG. 3, in operation ST1, upon receiving an instruction to start the interference checking process, the unit form calculation section 13 calculates the form (cube) of each unit in accordance with information on the forms and positions of all the components belonging to the unit, and stores the obtained form in the unit form storage section 21.

In part (1) of FIG. 4, external forms (cubes) 40 and 41 of two units A and B are calculated.

Here, the unit form calculation section 13, for example, notifies the first simple checking section 14a and the second simple checking section 14b of completion of the calculation and the number of units calculated.

The first simple checking section 14a performs processing of operations ST2 to ST5.

That is, upon receiving the notification indicating the completion of the calculation and the number of units calculated from the unit form calculation section 13, the first simple checking section 14a calculates, in accordance with the received notification indicating the number of units calculated, the number of times checking is to be performed, and sets the number of times checking is to be performed in the first counter.

The first simple checking section 14a reads the forms of the two units from the unit form storage section 211 checks whether a collision has occurred between the forms of the two units, and decrements the first counter by one (operation ST2).

In part (2) of FIG. 4, an example of the checking performed by the first simple checking section 14a is shown.

As shown in part (2) of FIG. 4, the first simple checking section 14a performs a first simple checking of whether a collision has occurred on one side of the cubic form of a unit.

Since a cube has six sides, six simple checking operations are performed in total for the unit with respect to different units.

If no collision has occurred (NO in operation ST3), the first simple checking section 14a determines that no component to be loaded, that is, no component to be subjected to strict interference checking by the interference checking section 17, exists in the two units (operation ST4). In this example, since the first counter has not reached zero (NO in operation ST5), the process returns to operation ST2 to perform similar simple checking for the next two units.

If, as a result (operation ST3) of simple checking (operation ST2), a state where no collision has occurred (NO in operation ST3) is maintained until the first counter indicates zero (YES in operation ST5), the entire interference checking process is completed.

Accordingly, notification indicating the appropriateness of the position design is transmitted, at such an early stage, from the data input/output section 24 to the display or the printer.

If, as a result (operation ST3) of simple checking (operation ST2) before the first counter reaches zero (including the first time) (NO in operation ST5), a collision has been detected (YES in operation ST3), the collision region form calculation section 15 calculates, as shown in part (3) of FIG. 4, the form (cube) of a collision region 42 of the colliding units 40 and 41 notified from the first simple checking section 14a, stores the obtained form of the collision region 42, in association with the two units 40 and 41 (identification codes), in the collision region form storage section 22, and notifies the second simple checking section 14b of completion of the calculation and the two units 40 and 41 (identification codes) (operation ST6).

Upon receiving the notification indicating the completion of the calculation and the number of units calculated from the unit form calculation section 13, the second simple checking section 14b calculates, in accordance with the received notification indicating the number of units calculated, the number of times checking is to be performed, as in the operation of the first simple checking section 14a, and sets the number of times checking is to be performed in the second counter. Then, the second simple checking section 14b waits until notification indicating the completion of calculation is received from the collision region form calculation section 15.

That is, upon receiving notification indicating the completion of the calculation from the collision region form calculation section 15, the second simple checking section 14b reads, based on the two units 40 and 41, the form of the collision region 42 from the collision region form storage section 22, and reads information on the forms and positions of components belonging to each of the two units 40 and 41 from the component form information storage section 18 and component position information storage section 19. Then, as shown in part (4) of FIG. 4, the second simple checking section 14b performs simple checking of whether a collision has occurred between the collision region 42 and any one of external forms 43 of the components in the units 40 and 41, and decrements the second counter by one (operation ST7).

Part (4) of FIG. 4 shows a case where two components belong to each of the units 40 and 41.

In this case, as shown in portions (a) to (d) of part (4) of FIG. 4, two simple checking operations are performed for each of the units 40 and 41.

However, the number of times checking is performed for each component is irrelevant to the processing of decrementing the second counter.

That is, as in the processing of decrementing the first counter, the processing of decrementing the second counter is performed for each unit.

As a result, as shown in portions (b) and (d) of part (4) of FIG. 4, if no collision has occurred (NO in operation ST8), the second simple checking section 14b determines that no component to be loaded, that is, no component to be subjected to strict interference checking by the interference checking section 17, exists in the two units 40 and 41 (operation ST9). In this example, since the second counter has not reached zero (NO in operation ST10), the process returns to operation ST2.

That is, the first simple checking section 14a resumes simple checking.

If, as a result (operation ST3) of simple checking (operation ST2) by the first simple checking section 14a, a collision has been detected (YES in operation ST3) and, as a result (operation ST8) of simple checking (operation ST7) by the second simple checking section 14b, a state where no collision has occurred (NO in operation ST8) is maintained until the second counter indicates zero (YES in operation ST10), the entire interference checking process is completed.

Accordingly, notification indicating the appropriateness of the position design is transmitted, at such an early stage, from the data input/output section 24 to the display or the printer.

If, as a result (operation ST3) of simple checking (operation ST2) by the first simple checking section 14a, a collision has been detected (YES in operation ST3) and, as a result (operation ST8) of simple checking (operation ST7) by the second simple checking section 14b, a collision has been detected (YES in operation ST8) as shown in portions (a) and (c) of part (4) of FIG. 4, the second simple checking section 14b notifies the loading execution section 16 of the names or symbols of the colliding components. Thus, the loading execution section 16 reads, based on the notified names or symbols of the components, information on the forms and positions of the components from the component form information storage section 18 and the component position information storage section 19, and loads geometric form data of the components into the interference checking storage section 23 (operation ST11).

In parallel with the loading processing (operation ST11) by the loading execution section 16, the second simple checking section 14b checks the second counter. If the second counter does not indicate zero (NO in operation ST12), the process returns to operation ST2.

That is, the first simple checking section 14a resumes simple checking.

As described above, if, as a result (operation ST3) of simple checking (operation ST2) by the first simple checking section 14a, a collision has been detected (YES in operation ST3) and, as a result (operation ST8) of simple checking (operation ST7) by the second simple checking section 14b, a collision has been detected (YES in operation ST8), geometric form data of colliding components detected before the second counter reaches zero (YES in operation ST12) is loaded into the interference checking storage section 23 (operation ST11).

When the second counter reaches zero, the second simple checking section 14b notifies the loading execution section 16 of the completion of detection. Then, the loading execution section 16 notifies the interference checking section 17 of the completion of loading.

Accordingly, the interference checking section 17 checks, based on geometric form data of the components that have been loaded into the interference checking storage section 23, whether interference has occurred between the components.

In the example shown in FIG. 4, as shown in part (5) of FIG. 4, checking for interference is performed for the colliding components in portions (a) and (c) of part (4) of FIG. 4.

In short, in a case where four components exist as shown in FIG. 4, for example, since only two of the four components are to be loaded, the number of components to be loaded is significantly reduced.

As described above, interference checking to be performed before components constituting a product are loaded into a memory section of a computer is performed only for units, which are grouped in terms of design. Thus, even in a case where a large number of components constitute each unit and a large number of combinations of components to be subjected to interference checking exist, interference checking can be performed independent of the influence of a large number of components constituting each unit, that is, interference checking for components in a round-robin fashion can be avoided.

In addition, interference checking to be performed before components constituting a product are loaded into a memory section of a computer is performed in a simple manner in which it is checked whether a collision has occurred between the forms of units. Thus, with the implementation of the above-described measures, an excellent processing response can be achieved.

Moreover, the number of components loaded into a memory section of a computer and subjected to strict interference checking can be significantly reduced. Thus, even for a large-scale assembly such as a car or a train, all the components necessary for interference checking can be loaded into the memory section of the computer so that interference checking can be performed.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An information processing device, comprising:
a first storage section configured to store information of forms and positions of a plurality of components constituting a product;
a second storage section configured to load geometric form data of components acquired from the information of the forms and positions of the components stored in the first storage section in a case where a position design of the product is performed by grouping the plurality of components into a plurality of units;
a first form calculation section configured to calculate a cubic form of each of the units, in accordance with information of forms and positions of components belonging to a unit read from the first storage section;
a first simple checking section configured to check whether a collision has occurred between cubic forms of two units calculated by the first form calculation section and to output information of the two units for which a collision has been detected;
a second form calculation section configured to calculate a cubic form of a collision region of the two units for which a collision has been detected in accordance with the information of the two units for which a collision has been detected received from the first simple checking section;
a second simple checking section configured to check whether a collision has occurred between the cubic form of the collision region calculated by the second form calculation section and a cubic form of any one of components belonging to the two units for which a collision has been detected by the first simple checking section and to output information of the components for which a collision has been detected when a collision is detected between the cubic form of the collision region and cubic forms of components belonging to the two units;
a loading execution section configured to load, into the second storage section, geometric form data of the components acquired in accordance with the information of the components received from the second simple checking section; and
an interference checking section configured to check whether an interference has occurred between the components and to evaluate the position design of the product in accordance with the geometric form data of the components that have been loaded in the second storage section.

2. A method for use in an information processing device including a first storage section configured to store information of forms and positions of a plurality of components constituting a product and a second storage section configured to, in a case where position design of the product is performed by grouping the plurality of components into a plurality of units, cause geometric form data of components acquired from information of forms and positions of the components stored in the first storage section to be loaded thereinto, the method comprising:
executing a first form calculation calculating a cubic form of each of the units, in accordance with information of forms and positions of components belonging to a unit read from the first storage section;
executing a first simple checking of whether a collision has occurred between cubic forms of two units calculated in the first form calculation and outputting information of the two units for which a collision has been detected;
executing a second form calculation calculating a cubic form of a collision region of the two units for which a collision has been detected in accordance with the information on of the two units for which a collision has been detected received in the first simple checking;
executing a second simple checking of whether a collision has occurred between the cubic form of the collision region calculated in the second form calculation and a cubic form of any one of components belonging to the two units for which a collision has been detected in the first simple checking and, outputting information of the components for which a collision has been detected when a collision is detected between the cubic form of the collision region and cubic forms of components belonging to the two units for which a collision has been detected;
loading, into the second storage section, geometric form data of the components acquired in accordance with the information of the components received in the second simple checking ; and
checking whether interference has occurred between the components, and evaluating the position design of the product in accordance with the geometric form data of the components that have been loaded in the second storage section.

3. A computer-readable recording medium having recorded thereon a program for causing an information processing device to operate as a first storage section configured to store information of forms and positions of a plurality of components constituting a product; and a second storage section configured to, in a case where position design of the product is performed by grouping the plurality of components into a plurality of units, cause geometric form data of components acquired from information of forms and positions of the components stored in the first storage section to be loaded thereinto, the program comprising:
executing a first form calculation calculating a cubic form of each of the units, in accordance with information of forms and positions of components belonging to the unit read from the first storage section;
executing a first simple checking of whether a collision has occurred between cubic forms of two units calculated in the first form calculation operation and, when a collision is detected, outputting information of the two units for which a collision has been detected;
executing a second form calculation calculating a cubic form of a collision region of the two units for which a collision has been detected in accordance with the information on of the two units for which a collision has been detected received in the first simple checking;
executing a second simple checking of whether a collision has occurred between the cubic form of the collision region calculated in the second form calculation and a cubic form of any one of components belonging to the two units for which a collision has been detected in the first simple checking and outputting information of the components for which a collision has been detected when a collision is detected between the cubic form of the collision region and cubic forms of components belonging to the two units for which a collision has been detected;
loading, into the second storage section, geometric form data of the components acquired in accordance with the information of the components received in the second simple checking; and
checking whether interference has occurred between the components, and evaluating the position design of the product in accordance with the geometric form data of the components that have been loaded in the second storage section.

4. An interference checking method, comprising:
calculating external cubes of units of a product using information of forms and positions of components;
calculating a collision region of two units determined to conflict;
checking whether a conflict has occurred between external cubes of each component and the collision region; and
determining whether an interference has occurred between the components and evaluating a position design of the product using data resulting from only said checking.
